(19) United States
(12) Patent Application Publication
(10) Pub. No.: US 2008/0123909 A1
(43) Pub. Date: May 29, 2008

(54) METHOD OF TRANSFORMING MINUTIAE USING TAYLOR SERIES FOR INTEROPERABLE FINGERPRINT RECOGNITION BETWEEN DISPARATE FINGERPRINT SENSORS

(75) Inventors: Hak Il Kim, Incheon (KR); Young Chan Han, Chungcheongnam-do (KR); Ji Hyeon Jang, Incheon (KR)

Correspondence Address: BACHMAN & LAPOINTE, P.C., 900 CHAPEL STREET, SUITE 1201, NEW HAVEN, CT, 06510, US

(73) Assignee: INHA-INDUSTRY PARTNERSHIP INSTITUTE, Incheon (KR)

(21) Appl. No.: 11/744,238

(22) Filed: May 4, 2007

(30) Foreign Application Priority Data
Sep. 12, 2006 (KR) 10-2006-0088212

(51) Int. Cl. G06K 9/00

(52) U.S. Cl. 382/125

(57) ABSTRACT

A method of transforming minutiae using the Taylor series for interoperable fingerprint recognition between disparate fingerprint sensors, which parses the fields of a Standard Interchange Format (SIF) template having the level of minutiae proposed in SC37, extract information fields corresponding to resolution, image size, and minutiae, corrects the locations of minutiae constituting the template, and standardizes the minutiae, thus increasing a recognition rate for fingerprint matching, and which applies transformation parameters using the Taylor series to a golden template that is generated using a plurality of samples for the same fingerprint which are input from a plurality of disparate fingerprint recognition sensors, thus improving recognition performance and reliability of matching between the disparate sensors that use the transformation of minutiae merely by correcting the locations of the minutiae, without correcting resolution or distortion characteristics. In the minutiae transformation method, a golden template, which is a template including visible minutiae, is created. Transformation parameters are calculated using the Taylor series. A location of minutiae data calculated from the SIF templates is corrected using the transformation parameters.

### BACKGROUND OF THE INVENTION

1. Field of the Invention

The present invention relates, in general, to a method of transforming minutiae using the Taylor series for interoperable fingerprint recognition between disparate fingerprint sensors and, more particularly, to a method of transforming minutiae using the Taylor series for interoperable fingerprint recognition between disparate fingerprint sensors, which parses the fields of a Standard Interchange Format (SIF) template having the level of minutiae proposed in an international fingerprint minutiae standard data format (the Biometrics sub-committee from the International Standards Organization [ISO]/International Electrotechnical Commission [IEC]: SC37), extract information fields corresponding to resolution, image size, and minutiae, corrects the locations of minutiae constituting the template, and standardizes the minutiae, thus increasing a recognition rate for fingerprint matching, and which applies transformation parameters using the Taylor series to a golden template that is generated using a plurality of samples for the same fingerprint which are input from a plurality of disparate fingerprint recognition sensors, thus improving recognition performance and reliability of matching between the disparate sensors that use the transformation of minutiae merely by correcting the locations of the minutiae, without correcting resolution or distortion characteristics.

2. Description of the Related Art

Generally, a fingerprint is a pattern generated by ridges, in which sweat glands protrude from the tip of each finger and which form certain flowing patterns, and people have their own inherent fingerprint patterns. Accordingly, fingerprint recognition is being widely popularized as a method of identifying a user using information devices and information services.

A typical fingerprint recognition system is operated such that a minutiae extraction module searches for the minutiae of a fingerprint, input through a fingerprint sensor, and a matching module searches for a matched fingerprint by comparing the input fingerprint with fingerprints previously registered in a database, thus identifying a user.

However, since current fingerprint sensors manufactured by respective manufacturing companies generate different fingerprint images (resolution, image size, color depth, and distortion rate) due to their different characteristics, minutia extraction and fingerprint matching functions are different for different manufacturing companies because they are adapted to suit the characteristics of images sensed by the fingerprint sensors at the time of capturing fingerprints.

Further, it is necessary to obtain feature vectors that are robust to various resolutions and different distortions of fingerprint images acquired by different fingerprint sensors in order to realize fingerprint recognition between disparate sensors. Further, in development companies, which provide application devices based on fingerprint recognition technology and services using Internet communication, fingerprint recognition systems made as products are not unified, thus acting as a factor that obstructs the development of products. Therefore, in order to overcome this obstruction, various methods have been proposed by various companies.

A ridge count method, among various methods, is a method generally used in an Automatic Fingerprint Identification System (AFIS) to identify fingerprints in relation to large-capacity fingerprint databases, and is implemented such that the number of ridges existing between minutiae is used as feature information and such that images input to the AFIS are images acquired by scanning fingerprints, impressed on paper in ink through rolling fingerprinting, at a high resolution using a planar scanner.

Further, a method proposed by NEC is implemented such that, when a single minutia is selected, virtual quadrants are defined on the basis of the direction of the selected minutia, and such that a structure, formed by selecting a minutia closest to the selected center minutia from among the minutiae placed in each quadrant, is defined and used as a local structure for matching. In the method, after a coordinate system is transformed using the direction information of the reference minutiae, whether a minutia adjacent to a reference minutia exists in each quadrant is examined, and the ridges existing between the reference minutia and the adjacent minutia are formed into a single group if minutiae exist in all four quadrants.

In this case, the algorithm proposed by NEC is advantageous in that matching can be attempted even for residual fingerprints, but is disadvantageous in that, since it is sensitive to the direction of minutiae, reproducibility decreases as the number of minutiae increases.

Meanwhile, a method proposed by IBM is implemented such that two minutiae are connected to each other using a virtual straight line composed of three to five pixels, three to five pixels are grouped into a single segment to examine whether each segment corresponds to a ridge or a valley, and thus information about the number of ridges is extracted. In this case, when the flow of ridges is suddenly changed, the reliability of the ridge count may decrease. Accordingly, information about the number of ridges is extracted only when the ridges are parallel to each other in a certain direction, thus improving the reliability of extraction.

For this operation, when the segment corresponding to each straight line connecting two minutiae is a ridge, information about the number of ridges is extracted, but, when at least one ridge is not parallel, the number of ridges between corresponding minutiae is ignored.

Further, a method proposed by Kovacs-Vajna is implemented such that the number of ridges is measured by profiling gray levels on the basis of a minutia placed at the center of an extracted minutiae image, and is used for matching.

Further, a method proposed by Germain is implemented such that the number of ridges formed in a triangle, in which three pairs of minutiae form a triplet, is defined, and the number of ridges existing between minutiae is used for matching. A method proposed by Ratha is implemented such that a star-shaped structure is defined using a single minutia and neighboring minutiae placed around the minutia within a certain distance, and the number of ridges existing between minutiae is used for matching.

In this way, there are attempts to recognize fingerprints between disparate sensors by extracting features that are robust to rotation, transition, magnification and reduction, without considering the characteristics of sensors, in order to recognize fingerprints between disparate sensors.

Further, SC37 has performed the standardization of a biometric recognition data format to implement various biometric recognition technologies and realize interoperability between systems. The International Labor Organization (ILO) has constructed a system for complying with the standard of interoperable formats, and has tested the system. NIST has provided a Minutiae Interoperability Exchange Test 2004 (MINEX04), so that 15 institutions are registered and tested for interoperability to determine the feasibility of using fingerprint minutiae data as fingerprint information between disparate fingerprint recognition systems.

However, despite the standardization of data formats, since disparate sensors have various Dot Per Inch (DPI) resolutions and image sizes, minutia-level matching, in which a correction procedure is omitted, greatly deteriorates the recognition rate because distortion characteristics appear differently for respective sensors.

### SUMMARY OF THE INVENTION

Accordingly, the present invention has been made keeping in mind the above problems occurring in the prior art, and an object of the present invention is to provide a method of transforming minutiae using the Taylor series for interoperable fingerprint recognition between disparate fingerprint sensors, which parses the fields of a Standard Interchange Format (SIF) template having the level of minutiae proposed in an international fingerprint minutiae standard data format (SC37), extract information fields corresponding to resolution, image size, and minutiae, corrects the locations of minutiae constituting the template, and standardizes the minutiae, thus increasing a recognition rate for fingerprint matching, and which applies transformation parameters using the Taylor series to a golden template that is generated using a plurality of samples for the same fingerprint which are input from a plurality of disparate fingerprint recognition sensors, thus improving recognition performance and reliability of matching between the disparate sensors that use the transformation of minutiae merely by correcting the locations of the minutiae, without correcting resolution or distortion characteristics.

In order to accomplish the above object, the present invention provides a method of transforming minutiae using Taylor series for interoperable fingerprint recognition between disparate fingerprint sensors, the method being implemented to transform minutiae for interoperable fingerprint recognition between disparate fingerprint sensors so as to perform matching between Standard Interchange Format (SIF) templates, acquired from the disparate fingerprint sensors, and an input image, comprising creating a golden template, which is a template including visible minutiae; calculating transformation parameters using the Taylor series; and correcting a location of minutiae data calculated from the SIF templates using the transformation parameters.

Preferably, the golden template may be created for fingerprint images of a same finger input from the disparate fingerprint sensors.

Preferably, the transformation parameters may be calculated from the golden template using the Taylor series and are implemented using average transformation parameters.

Preferably, the transformation parameters may be implemented such that average transformation parameters, used to eliminate noise, can be changed to parameters having a similar function when the transformation parameters are calculated.

Preferably, the transformation parameters may be implemented such that transformation relative to a golden template to be used as a reference, among arbitrary golden templates, is performed on an amount of translation and an amount of rotation when the transformation parameters are calculated.

Preferably, the transformation parameters may be implemented such that an order of the Taylor series can vary when the transformation parameters are calculated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of a system for correcting an input Standard Interchange Format (SIF) template on the basis of transformation parameters using the Taylor series and calculating similarity through the matching of the corrected SIF template with a registered SIF template according to the present invention;

FIG. 2 is a flowchart showing a method of transforming minutiae using the Taylor series for interoperable fingerprint recognition between disparate fingerprint sensors according to the present invention;

FIG. 3 is a view showing the concept of a method of transforming minutiae using the Taylor series for interoperable fingerprint recognition between disparate fingerprint sensors according to an embodiment of the present invention, using samples;

FIG. 4 is a graph showing Root Mean Square (RMS) errors obtained by the minutiae transformation method using the Taylor series for interoperable fingerprint recognition between disparate fingerprint sensors according to the present invention;

FIG. 5 is a diagram conceptually showing a procedure for calculating an average transformation parameter in the minutiae transformation method using the Taylor series for interoperable fingerprint recognition between disparate fingerprint sensors according to the present invention; and

FIG. 6 is a graph showing RMS errors obtained through the correction of the minutiae transformation method using the Taylor series for interoperable fingerprint recognition between disparate fingerprint sensors according to the present invention.

### DESCRIPTION OF THE PREFERRED EMBODIMENTS

Hereinafter, embodiments of the present invention will be described in detail with reference to the attached drawings.

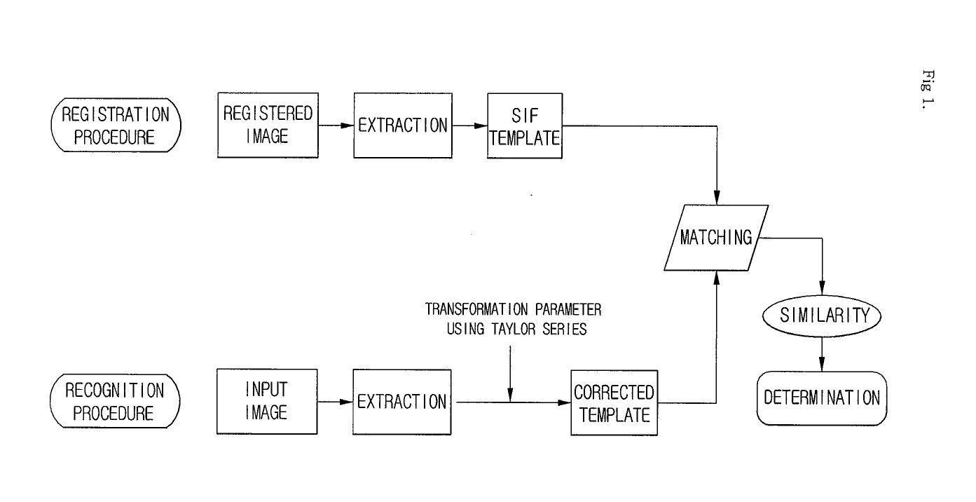

FIG. 1 is a block diagram showing the construction of a system for calculating similarity by matching an input Standard Interchange Format (SIF) template with an SIF template obtained by correcting and registering the input SIF template, on the basis of transformation parameters using the Taylor series of the present invention.

As shown in FIG. 1, the system parses the fields of the SIF template, extracts information about resolution, image size, and minutiae, inputs previously defined transformation parameters, corrects the minutiae of each input template on the basis of the transformation parameters, and performs matching using a corrected image or a corrected template.

In a procedure for calculating transformation parameters, transformation parameters are defined using both the Taylor series, indicating a power series when the real function of a real variable can be differentiated several times, and golden templates manufactured from respective sensor images.

Further, a procedure for calculating transformation parameters is performed by calculating the amount of translation and the amount of rotation of pairs of golden templates, other than a reference pair of golden templates, which will be used as a reference, as values relative to the reference golden template pair, and by generating pairs of golden templates in consideration of the amount of translation and the amount of rotation relative to the reference golden template pair.

Further, the amount of translation and the amount of rotation are precisely calculated for the identical-minutiae pairs in each golden template pair, and the average amount of translation and the average amount of rotation for all of the templates are calculated.

In this case, the amount of translation and the amount of rotation for golden template pairs, other than the reference golden template pair, which will be used as the reference, are calculated as values relative to the reference golden template pair, and golden template pairs are generated in consideration of the amount of translation and the amount of rotation relative to the reference golden template pair.

Further, input templates are corrected and errors are calculated using average transformation parameters for the generated golden template pairs.

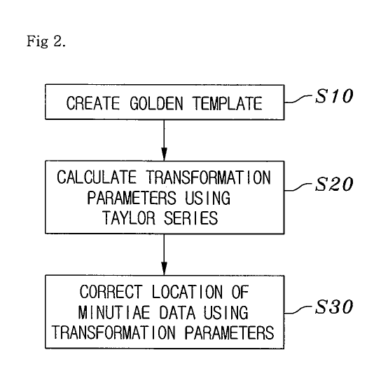

FIG. 2 is a flowchart showing a method of transforming minutiae using the Taylor series for interoperable fingerprint recognition between disparate fingerprint sensors according to the present invention. As shown in FIG. 2, a golden template is created at step S10, transformation parameters are calculated using the Taylor series at step S20, and the location of minutiae data calculated from the SIF template is corrected using the transformation parameters at step S30.

composed of visible minutiae perceptible by human eyes. A golden template editor is required in order to create the golden template. A template composed only of minutiae is using the golden template editor

Further, the created golden template includes basic minutiae information (location, direction, type, etc.), and a procedure for creating the golden template is implemented to open a fingerprint image, which is a target desired to be created as a golden template, select minutiae from the fingerprint image, create a list of minutiae, and store information about the created minutiae list.

In this case, in order to improve the recognition performance for fingerprint images having various types of distortions and resolutions by disparate fingerprint sensors, transformation parameters using the Taylor series are defined between images or templates registered in disparate fingerprint sensors and images or templates input by disparate fingerprint sensors, so that only the location of minutiae is corrected, without undertaking a procedure for correcting resolution or distortion, thus enabling fingerprint recognition between disparate fingerprint sensors.

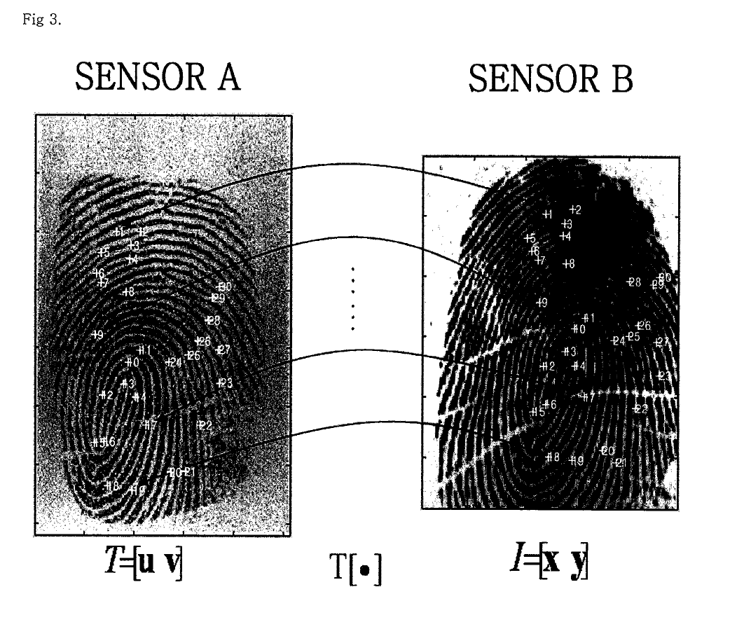

FIG. 3 is a view showing the concept of a method of transforming minutiae using the Taylor series for interoperable fingerprint recognition between disparate fingerprint sensors according to an embodiment of the present invention, using samples. As shown in FIG. 3, minutiae information extracted from an input template is calculated using transformation parameters that are obtained by applying the Taylor series to the registered template. The Taylor series has various forms according to order. In the method of transforming minutiae using the Taylor series for interoperable fingerprint recognition between disparate fingerprint sensors according to the present invention, second-order Taylor series is used and described

In this case, in disparate fingerprint recognition systems, a template registered through a predetermined sensor is designated as Template (T), an input received from a given sensor is designated as Input (I), the coordinates of the minutiae in the registered template (T) are set to (u, v), and the coordinates of the minutiae extracted from the Input (I) are set to (x, y).

A method of transforming minutiae using the Taylor series for interoperable fingerprint recognition between disparate fingerprint sensors according to the present invention is implemented to include a procedure for obtaining a transformation parameter by which the minutiae of the input (I) are translated into the same minutiae of the registered template (T).

In this case, it is assumed that the number of minutiae registered in the registered template (T) is p, that the number of minutiae extracted from the input (I) is p, and that the number of minutiae determined to belong to identical-minutiae pairs is M. When the relationship between them is represented in an equation, the following Equation [1] is obtained. The minutiae transformation method using the Taylor series for interoperable fingerprint recognition between disparate fingerprint sensors according to the present invention obtains transformation functions f and g, as shown in Equation [2].

T=[u,v] I=[x,y] [1]

u=f(x,y)v=g(x,y) [2]

Further, when the definition of the Taylor series is considered, a transformation equation h(x, y) can be represented using the following Equation [3]. When Equation [3] is rearranged for transformation coordinates (u, v), the transformation equation f(x, y) is represented by the following Equation [4], and the transformation equation g(x, y) is represented by the following Equation [5].

$$\begin{matrix}η = h ( 0 , 0 ) + {h}_{x}^{′} ( 0 , 0 ) x + {h}_{y}^{′} ( 0 , 0 ) y + \frac{1}{2 !} [ {h}_{xx}^{″} ( 0 , 0 ) {x}^{2} + {h}_{xy}^{″} ( 0 , 0 ) xy + {h}_{yy}^{″} ( 0 , 0 ) {y}^{2} ] + \frac{2}{3 !} [ {h}_{xxx}^{′″} ( 0 , 0 ) {x}^{3} + {h}_{xxy}^{′″} ( 0 , 0 ) {x}^{2} y + {h}_{xyy}^{′″} ( 0 , 0 ) {xy}^{2} + {h}_{yyy}^{′″} ( 0 , 0 ) {y}^{3} ] + & [ 3 ] \\ u = f ( 0 , 0 ) + {f}_{x}^{′} ( 0 , 0 ) x + {f}_{y}^{′} ( 0 , 0 ) y + \frac{1}{2 !} [ {f}_{xx}^{″} ( 0 , 0 ) {x}^{2} + {f}_{xy}^{″} ( 0 , 0 ) xy + {f}_{yy}^{″} ( 0 , 0 ) {y}^{2} ] + \frac{2}{3 !} [ {f}_{xxx}^{′″} ( 0 , 0 ) {x}^{3} + {f}_{xxy}^{′″} ( 0 , 0 ) {x}^{2} y + {f}_{xyy}^{′″} ( 0 , 0 ) {xy}^{2} + {f}_{yyy}^{′″} ( 0 , 0 ) {y}^{3} ] + & [ 4 ] \\ v = g ( 0 , 0 ) + {g}_{x}^{′} ( 0 , 0 ) x + {g}_{y}^{′} ( 0 , 0 ) y + \frac{1}{2 !} [ {g}_{xx}^{″} ( 0 , 0 ) {x}^{2} + {g}_{xy}^{″} ( 0 , 0 ) xy + {g}_{yy}^{″} ( 0 , 0 ) {y}^{2} ] + \frac{2}{3 !} [ {g}_{xxx}^{′″} ( 0 , 0 ) {x}^{3} + {g}_{xxy}^{′″} ( 0 , 0 ) {x}^{2} y + {g}_{xyy}^{′″} ( 0 , 0 ) {xy}^{2} + {g}_{yyy}^{′″} ( 0 , 0 ) {y}^{3} ] + & [ 5 ]\end{matrix}$$

When the above Equations [4] and [5] are rearranged in a simple polynomial form, the following Equation [6] is obtained, which can be rearranged to form the matrix equation of Equation [7].

$$\begin{matrix}u = {a}_{0} + {a}_{1} x + {a}_{2} y + {a}_{3} {x}^{2} + {a}_{4} xy + {a}_{5} {y}^{2} \\ v = {b}_{0} + {b}_{1} x + {b}_{2} y + {b}_{3} {x}^{2} + {b}_{4} xy + {b}_{5} {y}^{2} \\ u = {A}_{m} a \\ v = {A}_{m} b & [ 6 ] \\ {A}_{m} = [ \begin{matrix}1 & {x}_{1} & {y}_{1} & {x}_{1}^{2} & {x}_{1} {y}_{1} & {y}_{1}^{2} \\ 1 & {x}_{2} & {y}_{2} & {x}_{2}^{2} & {x}_{2} {y}_{2} & {y}_{2}^{2} \\ & & & ⋮ & & \\ 1 & {x}_{m} & {y}_{m} & {x}_{m}^{2} & {x}_{m} {y}_{m} & {y}_{m}^{2}\end{matrix} ] \\ a = {[ \begin{matrix}{a}_{0} & {a}_{1} & {a}_{2} & {a}_{3} & {a}_{4} & {a}_{5}\end{matrix} ]}^{T} \\ b = {[ \begin{matrix}{b}_{0} & {b}_{1} & {b}_{2} & {b}_{3} & {b}_{4} & {b}_{5}\end{matrix} ]}^{T} & \\ u = {[ {u}_{1} … {u}_{m} ]}^{T} \\ v = {[ {v}_{1} … {v}_{m} ]}^{T} & [ 7 ]\end{matrix}$$

When the results of the following Equation [8] are represented by a transformation parameter between the registered template and the template, extracted from the input image, the following Equation [9] is obtained, where W is a vector represented by u and v, and G is the resulting value of the Kronecker Product operation on a 2×2 unit matrix and a matrix of the coefficients of the Taylor series.

Therefore, W and G are well-known parameters, and the transformation parameter z to be calculated for correction is z. In order to calculate the transformation parameter z, an inverse matrix is used. When the second-order Taylor series is used, a desired transformation parameter can be obtained using an inverse matrix when six minutiae pairs are obtained.

$$W = Gz \\ \begin{matrix}w = [ \begin{matrix}u \\ v\end{matrix} ] \\ G = {I}_{2 \times 2} ⊗ {A}_{m} \\ z = [ \begin{matrix}a \\ b\end{matrix} ]\end{matrix} [ \begin{matrix}{u}_{1} \\ ⋮ \\ {u}_{m} \\ {v}_{1} \\ ⋮ \\ {v}_{m}\end{matrix} ] = {G}_{2 m \times 12} [ \begin{matrix}{a}_{0} \\ ⋮ \\ {a}_{5} \\ {b}_{0} \\ ⋮ \\ {b}_{5}\end{matrix} ] \qquad [ 8 ]$$

Further, from the standpoint of a fingerprint recognition system, in the case where six minutiae pairs are obtained, an exactly determined system can be implemented and thus only an inverse matrix need be obtained, as shown in Equation [9]. Actually, since six or more identical-minutiae pairs exist, an over-determined system is implemented. Therefore, in this case, the transformation parameter z can be calculated using the following Equation [10].

z=G⁻¹w

[9]

\hat{z}=(G^{T}G)⁻¹G^{T}w [10]

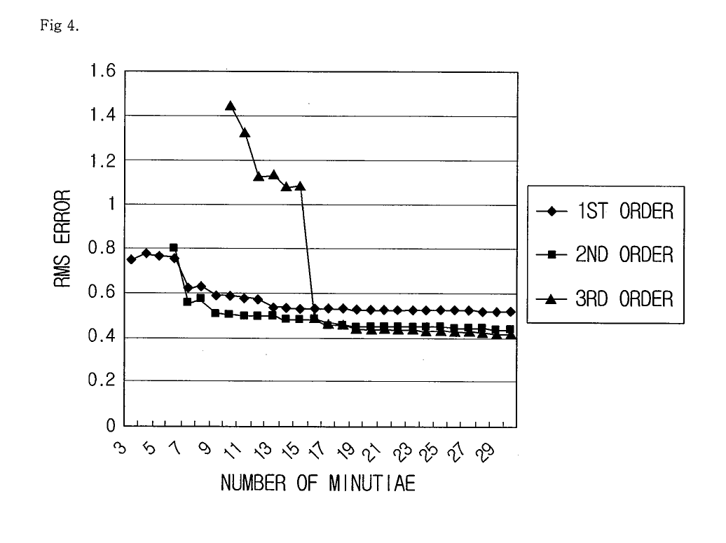

FIG. 4 is a graph showing Root Mean Square (RMS) errors obtained by the minutiae transformation method using the Taylor series for interoperable fingerprint recognition between disparate fingerprint sensors according to the present invention. As shown in FIG. 4, when a template is corrected using Equations [9] and [10], RMT errors obtained through correction are represented.

In this case, it can be seen that, as the order of the Taylor series increases, an RMS error obtained through correction decreases, and thus the RMS error is reduced when the number of identical-minutiae pairs is increased to a specific number or more.

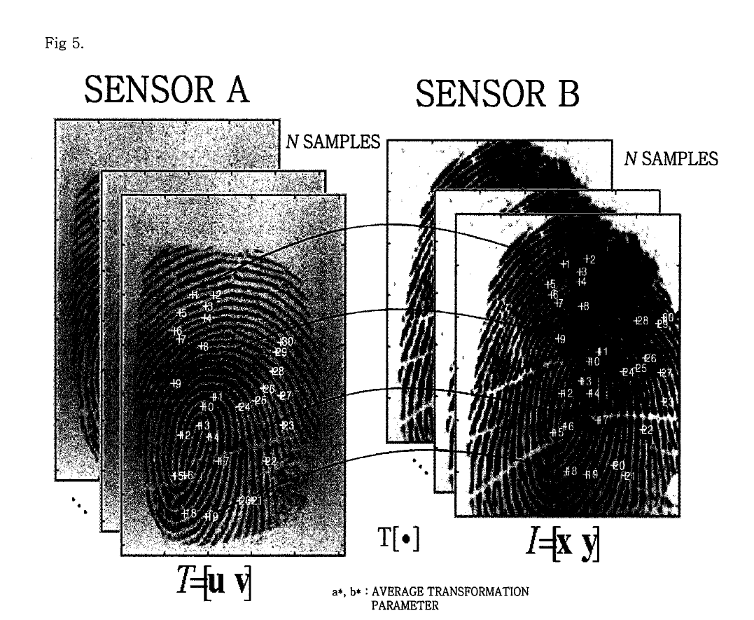

FIG. 5 is a diagram conceptually showing a procedure for calculating an average transformation parameter in the minutiae transformation method using the Taylor series for interoperable fingerprint recognition between disparate fingerprint sensors according to the present invention.

As shown in FIG. 5, when a transformation parameter calculated from a pair of samples is used, transformation noise may be contained in the transformation parameter. In order to solve the problem in which information about corrected minutiae is sensitive to noise, an average transformation parameter is calculated and used.

Further, in disparate fingerprint sensors, a single transformation parameter can be calculated from a golden template pair, and the application of the parameter calculated from the sample pair to a plurality of samples may cause correction errors.

Therefore, transformation parameters are calculated from a plurality of golden template samples, and thus transformation parameters having less error while reflecting the overall characteristics of the sensors can be obtained. Further, a single transformation parameter can be calculated from a single sample pair. However, since the extents of translation and transformation are different from each other for respective sample pairs, the calculation of transformation parameters for respective sample pairs is meaningless.

Therefore, in the minutiae transformation method using the Taylor series for interoperable fingerprint recognition between disparate fingerprint sensors according to the present invention, relative translation and rotation are considered on the basis of a single sample pair, all sample pairs used for correction must be provided with the same translation and rotation conditions, transformation parameters are calculated for respective sample pairs, and the average of all transformation parameters is finally calculated and used to eliminate noise, thus reducing correction errors.

Hereinafter, a process of calculating an average transformation parameter using the Taylor series for interoperable fingerprint recognition between disparate fingerprint sensors according to an embodiment of the present invention is summarized.

In each golden template pair, the amount of translation and the amount of rotation are precisely calculated for identical-minutiae pairs, and the average amount of translation and the average amount of rotation for all template pairs are obtained.

Further, the amount of translation and the amount of rotation for the golden template pairs, other than the reference golden template pair to be used as a reference, are calculated as values relative to the reference golden template pair, and golden template pairs are newly generated in consideration of the amount of translation and the amount of rotation relative to the reference golden template pair.

In addition, when a and b are obtained with respect to the generated golden template pairs, and the averages of respective values a and b are a* and b*, an input template pair is corrected and errors are calculated using the average transformation parameters a* and b*.

TABLE 1

| Average | Sensor | Sensor | Sensor |
|---|---|---|---|
| (a*, b*) | A-Sensor B | A-Sensor C | B-Sensor C |
| 2^{nd} order | −12.0246701 | 47.384573 | 53.901111 |
| | 1.1472892 | 1.031011 | 0.890185 |
| | 0.0187182 | 0.021319 | 0.002206 |
| | −0.0000721 | −0.000129 | 0.000017 |
| | −0.0001782 | −0.000154 | −0.000143 |
| | −0.0001273 | −0.000076 | 0.000083 |
| | 22.594588 | −34.687426 | −65.547075 |
| | 0.0604062 | −0.103195 | −0.068563 |
| | 1.0464116 | 0.822864 | 0.847153 |
| | −0.0004622 | 0.000406 | 0.000227 |
| | 0.0001697 | 0.000366 | 0.000241 |
| | 0.0001358 | 0.000211 | −0.000009 |

Table 1 shows examples of a* and b*, which are the average transformation parameters calculated using the Taylor series.

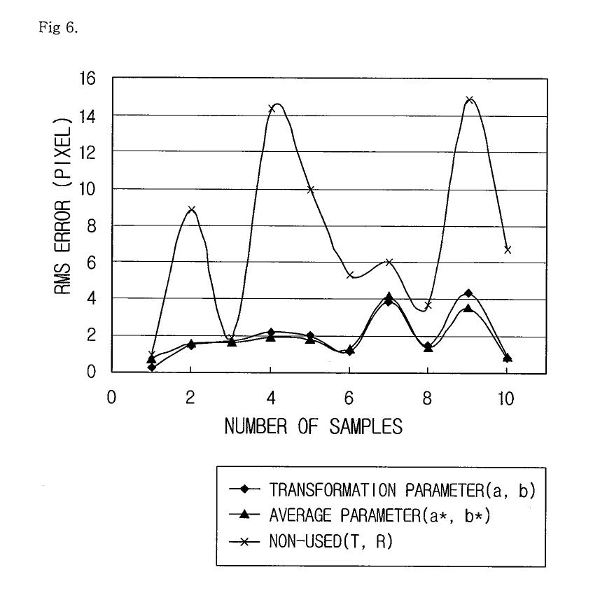

FIG. 6 is a graph showing RMS errors obtained through the correction of the minutiae transformation method using the Taylor series for interoperable fingerprint recognition between disparate fingerprint sensors according to the present invention.

As shown in FIG. 6, a transition in RMS errors, obtained through correction when transformation parameters using the Taylor series are not used, when the transformation parameters a and b are used for a single sample pair, and when average transformation parameters a* and b* calculated using the Taylor series are used, is illustrated.

In this case, the average transformation parameters calculated using the Taylor series according to the present invention are used, so that RMS errors obtained through correction are reduced.

In other words, the present invention extracts minutiae information from Standard Interchange Format (SIF)-templates having the level of minutiae proposed in an international fingerprint minutiae standard data format (SC37), corrects the minutiae information using the transformation parameters calculated using the Taylor series, and thus performs fingerprint recognition.

As described above, the present invention having the above construction is advantageous in that it provides a method of transforming minutiae using the Taylor series for interoperable fingerprint recognition between disparate fingerprint sensors, which parses the fields of a Standard Interchange Format (SIF) template having the level of minutiae proposed in an international fingerprint minutiae standard data format (SC37), extract information fields corresponding to resolution, image size, and minutiae, corrects the locations of minutiae constituting the template, and standardizes the minutiae, thus increasing a recognition rate for fingerprint matching, and which applies transformation parameters using the Taylor series to a golden template that is generated using a plurality of samples for the same fingerprint which are input from a plurality of disparate fingerprint recognition sensors, thus improving recognition performance and reliability of matching between the disparate sensors that use the transformation of minutiae merely by correcting the locations of the minutiae, without correcting resolution or distortion characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of transforming minutiae using Taylor series for interoperable fingerprint recognition between disparate fingerprint sensors, the method being implemented to transform minutiae for interoperable fingerprint recognition between disparate fingerprint sensors so as to perform matching between Standard Interchange Format (SIF) templates, acquired from the disparate fingerprint sensors, and an input image, comprising:
creating a golden template, which is a template including visible minutiae;
calculating transformation parameters using the Taylor series; and
correcting a location of minutiae data calculated from the SIF templates using the transformation parameters.

2. The method according to claim 1, wherein the golden template is created for fingerprint images of a same finger input from the disparate fingerprint sensors.

3. The method according to claim 1, wherein the transformation parameters are calculated from the golden template using the Taylor series and are implemented using average transformation parameters.

4. The method according to claim 1, wherein the transformation parameters are implemented such that average transformation parameters used to eliminate noise can be changed to parameters having a similar function when the transformation parameters are calculated.

5. The method according to claim 1, wherein the transformation parameters are implemented such that transformation relative to a golden template to be used as a reference, among arbitrary golden templates, is performed on an amount of translation and an amount of rotation when the transformation parameters are calculated.

6. The method according to claim 1, wherein the transformation parameters are implemented such that an order of the Taylor series can vary when the transformation parameters are calculated.
